(19) United States
(12) Patent Application Publication
(10) Pub. No.: US 2026/0034863 A1
(43) Pub. Date: Feb. 5, 2026

(54) COOLING SYSTEM

(71) Applicant: MAZDA MOTOR CORPORATION, Hiroshima (JP)

(72) Inventors: Kentaro KAWAGUCHI, Aki-gun (JP); Yuma MIYAUCHI, Aki-gun (JP)

(73) Assignee: MAZDA MOTOR CORPORATION, Hiroshima (JP)

(21) Appl. No.: 19/280,118

(22) Filed: Jul. 25, 2025

(30) Foreign Application Priority Data
Jul. 31, 2024 (JP) 2024-124219

(51) Int. Cl. B60H 1/32; B60H 1/00; F25B 9/00; F25B 41/31

(52) U.S. Cl. CPC B60H 1/3228; B60H 1/00278; F25B 9/008; F25B 41/31; B60H 2001/00307

(57) ABSTRACT

A cooling system includes a compressor that compresses a refrigerant, a heat exchanger that cools the refrigerant from the compressor, heat exchangers that use the refrigerant cooled by the heat exchanger, a refrigerant passage that supplies the refrigerant from the heat exchanger to a battery and returns this refrigerant to the compressor, and an expansion valve provided on the refrigerant passage, and processing circuitry increases the opening degree of the expansion valve within a range of a limit opening degree Lim1 or less as the battery temperature rises when abnormal heat generation of the battery is not occurring, and sets the opening degree of the expansion valve to a limit opening degree Lim2 larger than the limit opening degree Lim1 when abnormal heat generation of the battery is occurring.

### CROSS-REFERENCE TO RELATED APPLICATION

This application claims priority under 35 U.S.C. § 119(a) to Application No. 2024-124219, filed in Japan on Jul. 31, 2024, the entire contents of which is hereby incorporated by reference into the present application.

### TECHNICAL FIELD

One or more embodiments of the present disclosure relate to a cooling system that performs cooling inside a vehicle by circulating a refrigerant containing CO₂.

### BACKGROUND ART

A system that circulates a refrigerant through a compressor and a heat exchanger has been conventionally used in a refrigeration cycle used in an air conditioner. In addition, in recent years, such a system that circulates a refrigerant has also been used to cool a component inside a vehicle, for example, to cool a battery of an electric vehicle or a hybrid vehicle. In one example, Patent Literature 1 describes a system that cools and heats a battery cell by connecting a compressor, a first heat exchanger, and a second heat exchanger through a refrigerant channel and performing heat exchange between a refrigerant and the battery cell using the second heat exchanger.

### SUMMARY OF INVENTION

In recent years, there has been a growing requirement for cooling batteries due to quicker charging and higher power output of batteries, and a battery cooling technique using, for example, a cooling water that has insulating properties and can directly cool the inside of a battery has been developed. In such a battery cooling technique using a coolant or the like, while high cooling capability can be expected, pressure loss caused by the viscosity of oil occurs. In response to this, the present inventors considered using a refrigerant containing CO₂, the refrigerant having insulating properties and low viscosity (hereinbelow, referred to as the “CO₂ refrigerant” as appropriate), to efficiently cool a battery while reducing pressure loss. Since such a CO₂ refrigerant is a so-called natural refrigerant, influences on environment and the human body are also taken into consideration.

Here, in the cooling system that cools the battery using the refrigerant, in order to improve the cooling capability for the battery using the refrigerant, although it is desirable to ensure the amount of refrigerant supplied to the battery, the efficiency of the entire system (that is, the efficiency of the refrigeration cycle) is reduced if the amount of refrigerant supplied to the battery is increased.

On the other hand, abnormal heat generation of the battery may occur due to thermal runaway and/or an abnormal increase in temperature (i.e., a temperature rate increase above a predetermined value) caused by an internal short circuit or the like (caused by various reactions and thermal decomposition inside the battery, such as by overcharging, internal and external short circuits, high discharge rate, internal resistance caused by aging batteries and/or corrosion, defects, physical damage or electrolyte breakdown). When such abnormal heat generation occurs, it is desirable to ensure maximum cooling capability for the battery using the refrigerant in order to prioritize cooling of the battery.

The one or more embodiments have been made to solve the problems in the conventional technique described above, and an object thereof is, in a cooling system that cools a battery or the like inside a vehicle by circulating a refrigerant containing CO₂, to ensure maximum cooling capability for the battery using the refrigerant during abnormal heat generation of the battery while ensuring the efficiency of the entire system.

### Means for Solving the Problems

In order to achieve the above-mentioned object, the one or more embodiments includes a cooling system that performs cooling inside a vehicle by circulating a refrigerant containing CO₂, the cooling system including: a compressor that compresses the refrigerant; a first heat exchanger for cooling the refrigerant compressed by the compressor; a second heat exchanger for performing at least air conditioning of the vehicle using the refrigerant cooled by the first heat exchanger; a refrigerant passage for supplying the refrigerant to a battery inside the vehicle to cool the battery using the refrigerant cooled by the first heat exchanger and supplying the refrigerant that has been used for cooling in the battery to the compressor; an expansion valve for expanding the refrigerant, the expansion valve being provided on the refrigerant passage upstream of the battery; and a control device configured to obtain a temperature of the battery and control the expansion valve on the basis of the temperature of the battery, characterized in that the control device is configured to increase an opening degree of the expansion valve within a range of a predetermined first opening degree or less as the temperature of the battery rises when abnormal heat generation of the battery is not occurring, and set the opening degree of the expansion valve to a second opening degree larger than the first opening degree when abnormal heat generation of the battery is occurring.

According to the one or more embodiments configured in this manner, one system (cooling system) that circulates the refrigerant can appropriately achieve air conditioning of the vehicle and cooling of the battery. In addition, according to the one or more embodiments, when abnormal heat generation of the battery is not occurring, it is possible to ensure the cooling capability for the battery using the refrigerant while restraining a reduction in the efficiency of the entire system by increasing the opening degree of the expansion valve within the range of the first opening degree or less as the battery temperature rises. On the other hand, according to the one or more embodiments, when abnormal heat generation of the battery is occurring, it is possible to maximize the cooling capability for the battery using the refrigerant and give top priority to cooling of the battery by setting the opening degree of the expansion valve to the second opening degree larger than the first opening degree. As a result, it is possible to restrain abnormal heat generation of the battery, and avoid a battery fire, which is the worst case.

In the one or more embodiments, preferably, the control device is configured to first set the opening degree of the expansion valve to the first opening degree when abnormal heat generation of the battery occurs, and then set the opening degree of the expansion valve to the second opening degree when the temperature of the battery continues to rise.

According to the one or more embodiments configured in this manner, since the expansion valve is controlled in stages from the first opening degree to the second opening degree when abnormal heat generation of the battery occurs, it is possible to increase the cooling capability for the battery using the refrigerant while minimizing the rise in the temperature of the refrigerant discharged from the compressor.

In the one or more embodiments, preferably, the cooling system further includes, when the refrigerant passage is defined as a first refrigerant passage and the expansion valve is defined as a first expansion valve, a second refrigerant passage for supplying the refrigerant that has been used for cooling in the second heat exchanger to the compressor, without passing the refrigerant through the first refrigerant passage, and a second expansion valve for expanding the refrigerant, the second expansion valve being provided on the second refrigerant passage, and the control device is configured to increase an opening degree of the second expansion valve as the opening degree of the first expansion valve increases when abnormal heat generation of the battery is not occurring, and reduce the opening degree of the second expansion valve as the opening degree of the first expansion valve increases when abnormal heat generation of the battery is occurring.

According to the one or more embodiments configured in this manner, when abnormal heat generation of the battery is not occurring, it is possible to restrain the rise in the temperature of the refrigerant discharged from the compressor by increasing the flow rate of the refrigerant supplied from the second refrigerant passage to the compressor through the second expansion valve in accordance with the increase in the flow rate of the refrigerant supplied from the first refrigerant passage to the compressor through the first expansion valve. As a result, for example, it is possible to restrain the occurrence of a decline in the function of oil in the refrigerant or deterioration of the oil. On the other hand, when abnormal heat generation of the battery is occurring, it is possible to allow the temperature of the refrigerant discharged from the compressor to rise and give top priority to cooling of the battery by reducing the flow rate of the refrigerant supplied from the second refrigerant passage to the compressor through the second expansion valve.

In the one or more embodiments, preferably, the first opening degree is set on the basis of the opening degree of the expansion valve for making the temperature of the refrigerant discharged from the compressor equal to or lower than a predetermined temperature.

According to the one or more embodiments configured in this manner, when abnormal heat generation of the battery is not occurring, the temperature of the refrigerant discharged from the compressor can be made equal to or lower than the predetermined temperature by limiting the opening degree of the expansion valve to the first opening degree or less.

In the one or more embodiments, preferably, the control device is configured to determine whether abnormal heat generation of the battery is occurring by detecting an internal short circuit of the battery.

According to the one or more embodiments configured in this manner, it is possible to properly determine the occurrence of abnormal heat generation of the battery.

In the one or more embodiments, preferably, the cooling system further includes a battery heat exchanger for directly cooling a plurality of cells inside the battery using the refrigerant by passing the refrigerant in the refrigerant passage around the plurality of cells, and the battery heat exchanger is supplied with the refrigerant decompressed by the expansion valve.

According to the one or more embodiments configured in this manner, since the plurality of cells are directly cooled using the refrigerant in the battery heat exchanger, it is possible to effectively cool the plurality of cells. In this case, since it is not desirable to supply the high-pressure refrigerant from the compressor as it is to the battery heat exchanger because the pressure resistance of a battery pack and the like is relatively low, the refrigerant from the compressor is decompressed by the expansion valve and supplied to the battery heat exchanger in the one or more embodiments. Accordingly, it is possible to properly protect the inside of the battery (such as the plurality of cells).

In the one or more embodiments, preferably, the second heat exchanger includes an air conditioning heat exchanger for performing air conditioning of the vehicle, and further includes a battery heat exchanger for indirectly cooling a plurality of cells using the refrigerant by supplying the refrigerant to outside of a battery pack including the plurality of cells in the battery.

According to the one or more embodiments configured in this manner, by using the battery heat exchanger that supplies the refrigerant to the outside of the battery pack, it is possible to appropriately cool the battery and achieve relatively large heat exchange with the refrigerant.

In the one or more embodiments, preferably, the first heat exchanger is configured as a cascade heat exchanger that performs heat exchange between a first heat cycle circuit including at least the compressor, the second heat exchanger, the refrigerant passage, and the expansion valve and a second heat cycle circuit including an outside air heat exchanger that exchanges heat with outside air separately from the first heat cycle circuit.

According to the one or more embodiments configured in this manner, by causing the first heat cycle circuit to perform heat exchange (cascade heat exchange) with the second heat cycle circuit that exchanges heat with the outside air, it is possible to improve the efficiency of the entire system of the first heat cycle circuit, in other words, reduce the work of the compressor inside the first heat cycle circuit.

In the one or more embodiments, preferably, the cooling system is configured to further cool, using the refrigerant cooled by the first heat exchanger, a motor that drives the vehicle using electric power of the battery.

According to the one or more embodiments configured in this manner, one system (e.g., cooling system) that circulates the refrigerant can appropriately achieve cooling of various components inside the vehicle, such as the motor.

### Advantageous Effects of Invention

According to the one or more embodiments, in a cooling system that cools a battery or the like inside a vehicle by circulating a refrigerant containing CO₂, it is possible to ensure maximum cooling capability for the battery using the refrigerant during abnormal heat generation of the battery while ensuring the efficiency of the entire system.

### BRIEF DESCRIPTION OF DRAWINGS

FIG. 1 is a schematic configuration diagram of a vehicle to which a cooling system according to an embodiment of the one or more embodiments is applied.

FIG. 2 is a schematic configuration diagram of the cooling system according to one or more embodiments of the present disclosure.

(a) of FIG. 3 and (b) of FIG. 3 are schematic configuration diagrams of a first battery heat exchanger and a second battery heat exchanger according to the one or more embodiments of the present disclosure, respectively.

FIG. 4 is a block diagram showing an electrical configuration of the cooling system according to the one or more embodiments of the present disclosure.

(a) of FIG. 5 and (b) of FIG. 5 respectively show control of an E2 opening degree and control of an E3 opening degree that are performed during steady traveling or slow charging in the one or more embodiments of the present disclosure.

(a) of FIG. 6 and (b) of FIG. 6 respectively show control of the E2 opening degree and control of the E3 opening degree that are performed during quick charging in the one or more embodiments of the present disclosure.

(a) of FIG. 7 and (b) of FIG. 7 respectively show control of the E2 opening degree and control of the E3 opening degree that are performed during abnormal heat generation of a battery in the one or more embodiments of the present disclosure.

### MODE FOR CARRYING OUT THE INVENTION

Hereinbelow, a cooling system according to one or more embodiments of the present disclosure will be described with reference to the accompanying drawings.

### Entire Configuration

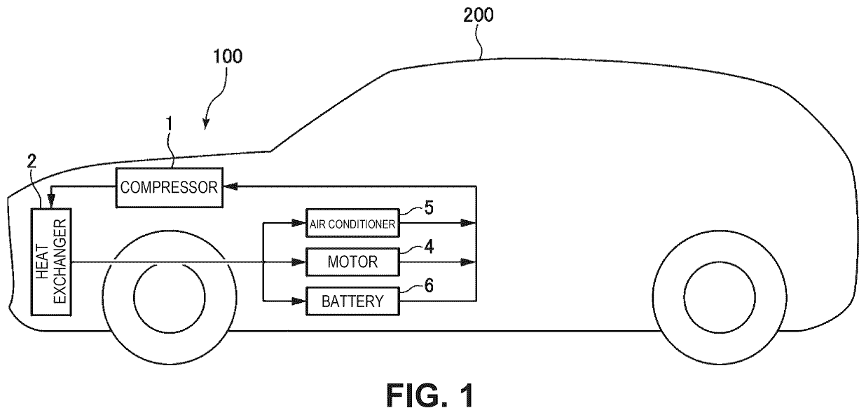

First, the entire configuration of the cooling system according to the present embodiment will be described with reference to FIG. 1. FIG. 1 is a schematic configuration diagram of a vehicle to which the cooling system according to the present embodiment is applied.

As shown in FIG. 1, a vehicle 200 is, for example, an electric vehicle, and includes a cooling system 100 that circulates a refrigerant in a refrigeration cycle. The cooling system 100 mainly includes a compressor 1 for compressing the refrigerant, a heat exchanger 2 for cooling the refrigerant compressed by the compressor 1, a motor (e.g., electric motor) 4 for generating power to drive the vehicle 200, an air conditioner 5 that performs air conditioning inside the vehicle 200, and a battery 6 that supplies electric power to drive the motor 4.

The cooling system 100 circulates a CO₂ refrigerant (hereinbelow, may be simply referred to as the “refrigerant”) as a natural refrigerant. Typically, the CO₂ refrigerant is a refrigerant containing CO₂, a refrigerating machine oil (e.g., oil) such as Polyalkylene Glycol (PAG), and an additive. Since such a CO₂ refrigerant is used, the compressor 1 is configured to compress the refrigerant to an extremely high pressure. The motor 4 uses the refrigerant (e.g., in a liquid state (typically, in a supercritical state)) compressed by the compressor 1 in this manner for cooling of a rotor and a stator. In addition, the motor 4 is configured to also use the refrigerant for lubrication of a sliding bearing that supports a rotation shaft. In addition, the refrigerant compressed by the compressor 1 is used for air conditioning in the air conditioner 5 and cooling of the battery 6. For example, in the cooling system 100, the high-temperature and high-pressure gas refrigerant is supplied from the compressor 1 to the heat exchanger 2, the low-temperature and high-pressure liquid refrigerant is supplied from the heat exchanger 2 to the motor 4 and the like, and the normal-temperature and low-pressure gas refrigerant is supplied from the motor 4 and the like to the compressor 1.

### Configuration of Cooling System

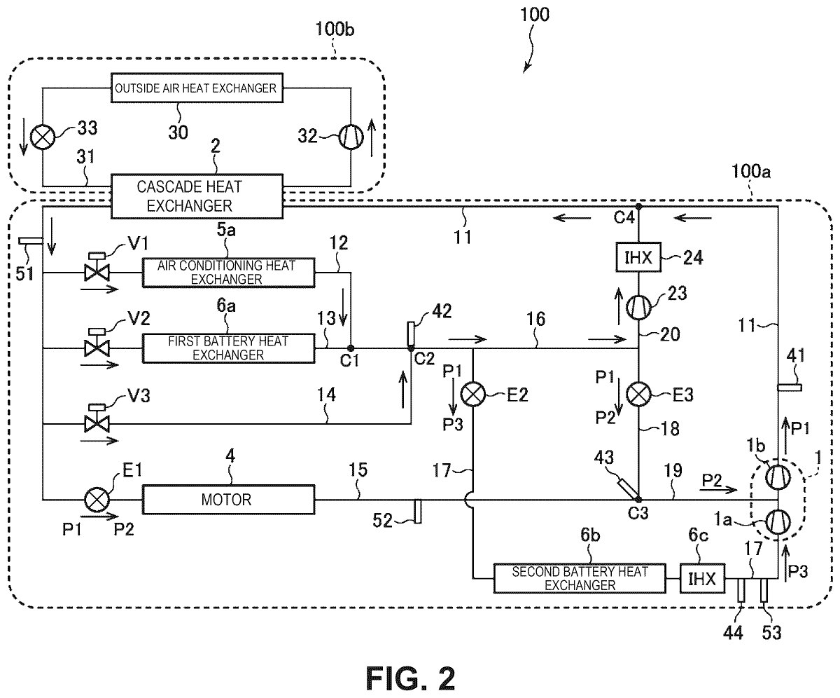

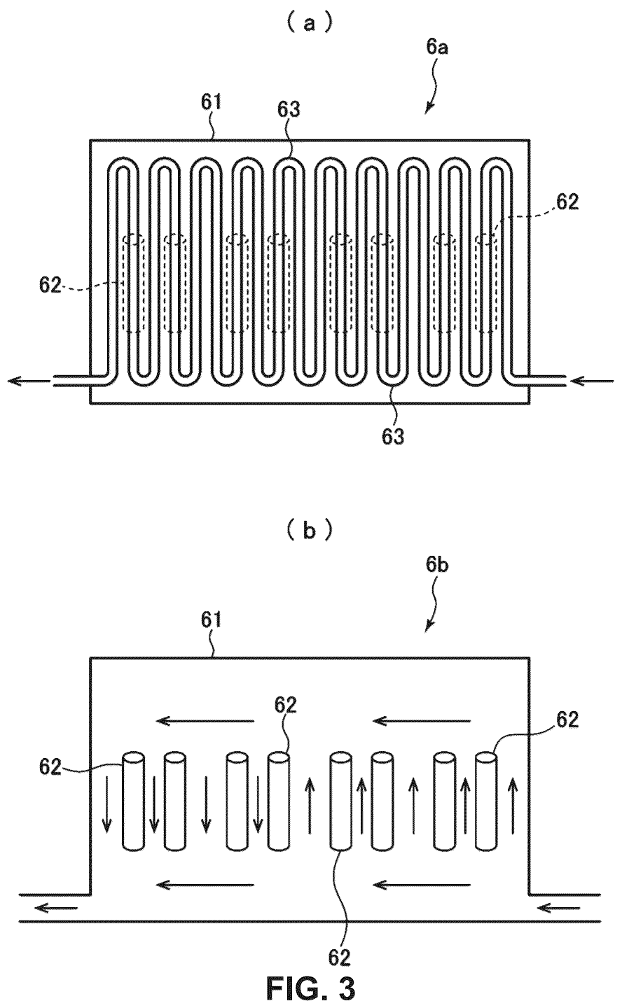

Next, the cooling system 100 according to the present embodiment will be specifically described with reference to FIG. 2. FIG. 2 is a schematic configuration diagram of the cooling system 100 according to the present embodiment.

As shown in FIG. 2, the cooling system 100 includes a first heat cycle circuit (e.g., low-temperature circuit) 100a that circulates the above-mentioned CO₂ refrigerant, and a second heat cycle circuit (e.g., high-temperature circuit) 100b that includes an outside air heat exchanger 30 that exchanges heat with outside air and circulates a refrigerant such as propane or a fluorine-based refrigerant, and is configured to achieve a cascade refrigeration cycle. Specifically, the first heat cycle circuit 100a and the second heat cycle circuit 100b perform cascade heat exchange in the heat exchanger 2 (hereinbelow, the heat exchanger 2 is referred to as the “cascade heat exchanger 2” as appropriate). The cascade heat exchanger 2 corresponds to the “first heat exchanger” in the one or more embodiments.

The first heat cycle circuit 100a of the cooling system 100 mainly includes, in addition to the compressor 1 and the motor 4 described above, an air conditioning heat exchanger 5a for performing heat exchange in the air conditioner 5 (e.g., specifically, an evaporator that generates cold air to be supplied to the inside of the vehicle), a first battery heat exchanger 6a and a second battery heat exchanger 6b that perform heat exchange to cool the battery 6, refrigerant passages 11 to 20 through which the refrigerant flows, a pressure feeder 23 that pressure-feeds the refrigerant, flow control valves V1, V2, V3 that adjust the flow rate of the refrigerant, and expansion valves E1, E2, E3 that expand and decompress the refrigerant.

In the present embodiment, the compressor 1 includes a first compressor 1a on the upstream side and a second compressor 1b on the downstream side, and is configured to compress the refrigerant in two stages. The first compressor 1a increases a pressure P3 of the refrigerant to a pressure P2 (e.g., the pressure P2>the pressure P3), and the second compressor 1b increases the pressure P2 of the refrigerant to a pressure P1 (e.g., the pressure P1>the pressure P2). In one example, the pressure P1 is approximately 3 MPa, the pressure P2 is approximately 1.5 MPa, and the pressure P3 is approximately 0.1 MPa.

In addition, in the present embodiment, the battery 6 is configured to be cooled by two heat exchangers, that is, the first battery heat exchanger 6a and the second battery heat exchanger 6b. The configuration of the first battery heat exchanger 6a and the second battery heat exchanger 6b will be described with reference to (a) of FIG. 3 and (b) of FIG. 3. (a) of FIG. 3 and (b) of FIG. 3 schematically show examples of the first battery heat exchanger 6a and the second battery heat exchangers 6b, respectively. More specifically, FIG. 3 (a) is a plan view of a battery pack 61 of the battery 6 viewed from the outside, and (b) FIG. 3 is a plan perspective view of the inside of the battery pack 61.

As shown in (a) of FIG. 3, the first battery heat exchanger 6a is configured to indirectly cool a plurality of cells 62 inside the battery 6 using the refrigerant by supplying the refrigerant to the outside of the battery pack 61 (typically, the surface of a case) including the plurality of cells 62 in the battery 6, more specifically, by passing the refrigerant through a channel 63 that is formed in a meandering manner. Note that the configuration that indirectly cools the cells 62 inside the battery 6 using the refrigerant is not limited to the configuration shown in (a) of FIG. 3, and various known configurations can be adopted. On the other hand, as shown in (b) of FIG. 3, the second battery heat exchanger 6b is configured to directly cool the plurality of cells 62 using the refrigerant by passing the refrigerant around the plurality of cells 62 inside the battery 6, that is, by passing the refrigerant inside the battery pack 61. Note that the first battery heat exchanger 6a and the air conditioning heat exchanger 5a described above correspond to the “second heat exchanger” in the present invention. In this case, the air conditioning heat exchanger 5a cools the evaporator (e.g., cooling target) of the air conditioner 5 using the refrigerant, and the first battery heat exchanger 6a cools the battery 6 (e.g., cooling target) using the refrigerant.

Referring back to FIG. 2, the flow of the refrigerant inside the first heat cycle circuit 100a will be specifically described. The refrigerant compressed by the compressor 1 is supplied from the refrigerant passage 11 to the cascade heat exchanger 2, and the refrigerant cooled by the cascade heat exchanger 2 is supplied from the refrigerant passages 12, 13, 15 connected to the refrigerant passage 11 to the air conditioning heat exchanger 5a, the first battery heat exchanger 6a, and the motor 4, respectively. The refrigerant passage 12 and the refrigerant passage 13 join at a confluence C1 and are connected to the refrigerant passage 16, which causes the refrigerant that has exchanged heat in the air conditioning heat exchanger 5a and the refrigerant that has exchanged heat in the first battery heat exchanger 6a to be supplied to the refrigerant passage 16. In addition, the refrigerant cooled by the cascade heat exchanger 2 is directly supplied to the refrigerant passage 16 through the refrigerant passage 14 that is connected to the refrigerant passage 11, without passing through the air conditioning heat exchanger 5a and the first battery heat exchanger 6a (that is, bypassing the refrigerant passages 12, 13, 15). In this case, the refrigerant passage 14 and the refrigerant passage 16 join at a confluence C2 that is downstream of the confluence C1 described above. In addition, the refrigerant passages 12, 13, 14 are respectively provided with the flow control valves V1, V2, V3 for adjusting the flow rate of the refrigerant flowing through each passage, and the refrigerant passage 15 is provided with the expansion valve E1 for expanding the refrigerant to be supplied to the motor 4. The expansion valve E1 functions to decompress the refrigerant from the pressure P1 to the pressure P2.

In addition, the refrigerant passage 17 is connected to the refrigerant passage 16 so that the refrigerant inside the refrigerant passage 16 is supplied from the refrigerant passage 17 to the second battery heat exchanger 6b. In the refrigerant passage 17, the expansion valve E2 for expanding the refrigerant is provided upstream of the second battery heat exchanger 6b, which causes the refrigerant decompressed by the expansion valve E2 to be supplied to the second battery heat exchanger 6b. The expansion valve E2 functions to decompress the refrigerant from the pressure P1 to the pressure P3. In addition, in the refrigerant passage 17, an internal heat exchanger (IHX) 6c having a known double-tube structure is provided downstream of the second battery heat exchanger 6b, and the downstream side thereof is further connected to the first compressor 1a of the compressor 1. The refrigerant having the pressure P3 decompressed by the above-mentioned expansion valve E2 is supplied to the first compressor 1a.

Furthermore, the refrigerant passage 16 branches into the refrigerant passage 18 and the refrigerant passage 20 at a position downstream of a connection point with the refrigerant passage 17. The refrigerant passage 18 is provided with the expansion valve E3 for expanding the refrigerant. The expansion valve E3 functions to decompress the refrigerant from the pressure P1 to the pressure P2. In addition, at a confluence C3 that is downstream of the expansion valve E3, the refrigerant passage 18 joins the refrigerant passage 15 that is provided with the motor 4 described above, and the refrigerant passages 15, 18 are connected to the refrigerant passage 19. The refrigerant passage 19 is connected between the first compressor 1a and the second compressor 1b of the compressor 1, and supplies the refrigerant having the pressure P2 decompressed by the expansion valve E1 and the expansion valve E3 to the second compressor 1b. On the other hand, the refrigerant passage 20 is connected, at a confluence C4 on its downstream side, to the refrigerant passage 11 between the compressor 1 and the cascade heat exchanger 2. The refrigerant passage 20 is provided with the pressure feeder 23 and an internal heat exchanger (IHX) 24 having a known double-tube structure. Such a refrigerant passage 20 enables the pressure feeder 23 to supply the refrigerant from the above-mentioned refrigerant passage 16 to the cascade heat exchanger 2, without passing the refrigerant through the compressor 1 (that is, bypassing the compressor 1).

Note that the refrigerant passage 17 corresponds to the “first refrigerant passage” in the one or more embodiments, and the refrigerant passages 18 and 19 correspond to the “second refrigerant passage” in the one or more embodiments. In addition, the expansion valve E2 corresponds to the “first expansion valve” in the one or more embodiments, and the expansion valve E3 corresponds to the “second expansion valve” in the one or more embodiments.

Next, the second heat cycle circuit 100b of the cooling system 100 is a high-temperature circuit that circulates the refrigerant such as propane or a fluorine-based refrigerant as described above, and includes, in addition to the outside air heat exchanger 30 that exchanges heat with the outside air, a refrigerant passage 31 through which the refrigerant flows, a pressure feeder 32 that pressure-feeds the refrigerant, and an expansion valve 33 that expands the refrigerant. In the cooling system 100 according to the present embodiment, providing such a second heat cycle circuit 100b separately from the first heat cycle circuit 100a improves the efficiency of the entire system of the first heat cycle circuit 100a, in other words, reduces the work of the compressor 1.

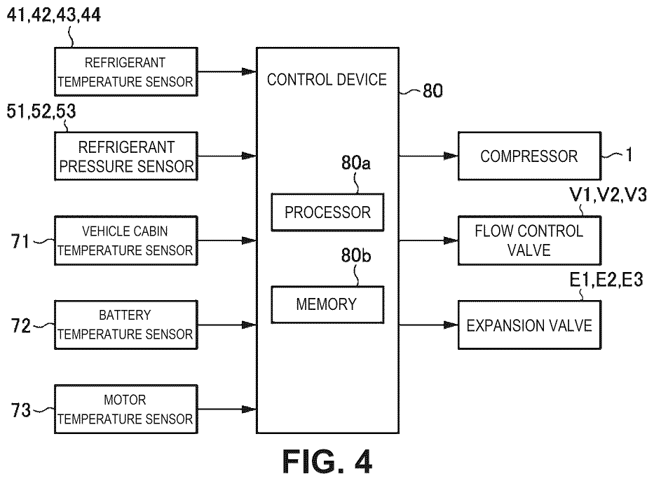

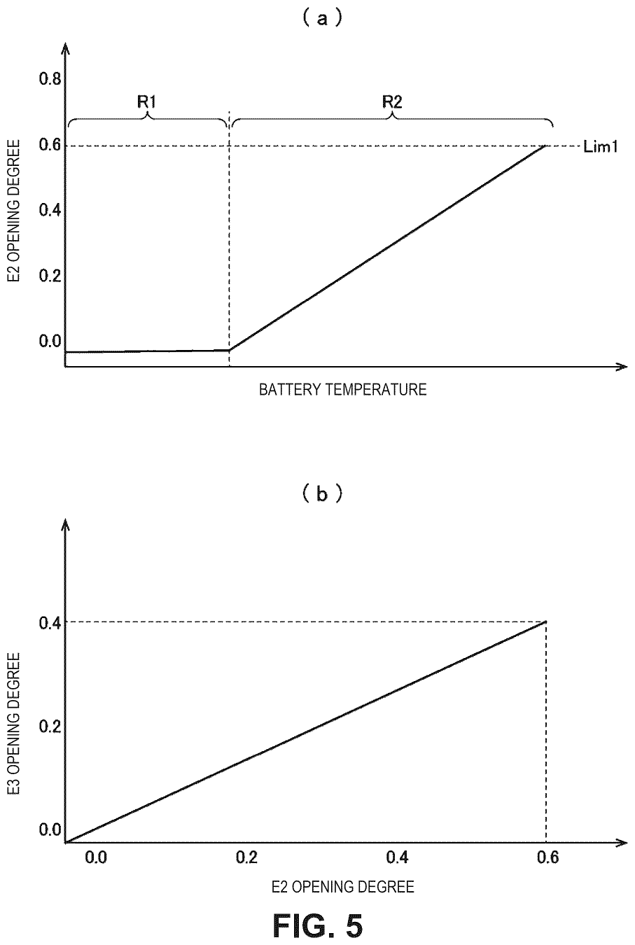

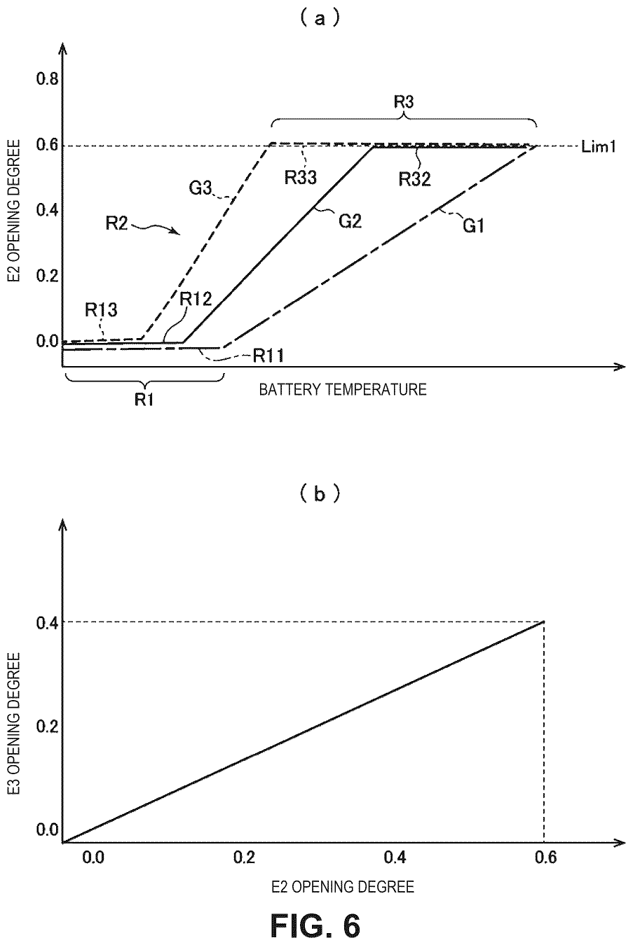

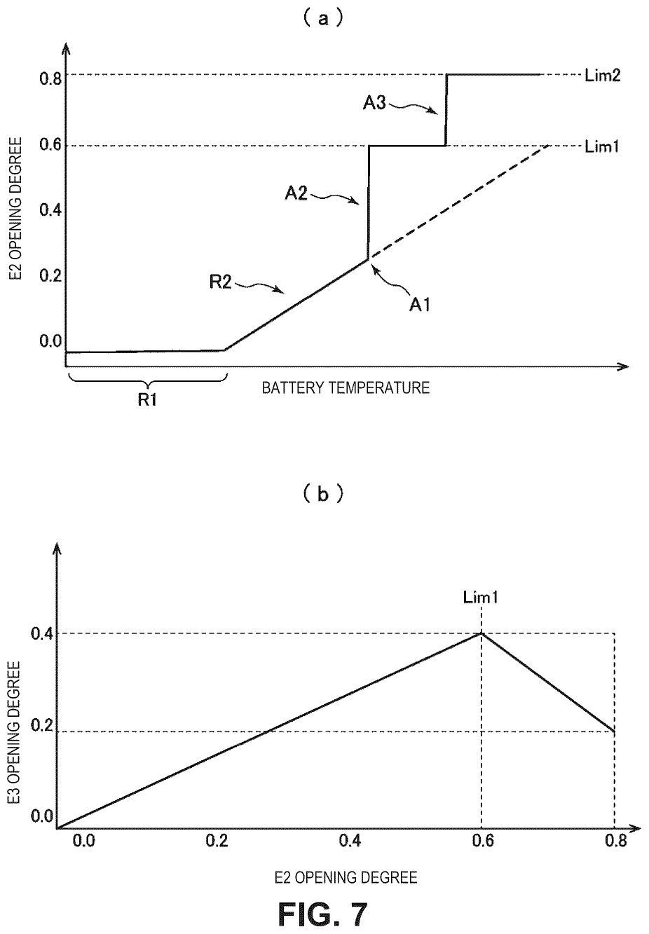

Next, the electrical configuration of the cooling system 100 according to the present embodiment will be described with reference to FIG. 4 in addition to FIG. 2. FIG. 4 is a block diagram showing the electrical configuration of the cooling system 100 according to the present embodiment.

As shown in FIG. 4, the cooling system 100 includes a control device 80 that is configured to perform various types of control in the system. The control device 80 is composed of a computer including one or more processors 80a (e.g., typically, CPUs), and a memory 80b such as a ROM or a RAM that stores various programs (e.g., including a basic control program such as an OS and an application program that is started on the OS to implement a specific function) that are interpreted and executed on the processor 80a, and various data. The functionality of the elements disclosed herein may be implemented using circuitry or processing circuitry which includes general purpose processors, special purpose processors, integrated circuits, ASICs (“Application Specific Integrated Circuits”), FPGAS (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

In addition, the cooling system 100 includes refrigerant temperature sensors 41, 42, 43, 44 that detect the temperature of the refrigerant and refrigerant pressure sensors 51, 52, 53 that detect the pressure of the refrigerant, the refrigerant temperature sensors 41, 42, 43, 44 and the refrigerant pressure sensors 51, 52, 53 being provided in the first heat cycle circuit 100a (refer to FIG. 2), a vehicle cabin temperature sensor 71 that detects the temperature of a vehicle cabin (e.g., cabin), a battery temperature sensor 72 that detects the temperature of the battery 6 (hereinbelow, referred to as the “battery temperature” as appropriate), and a motor temperature sensor 73 that detects the temperature of the motor 4. Specifically, as shown in FIG. 2, the refrigerant temperature sensor 41 is provided on the refrigerant passage 11 between the compressor 1 and the cascade heat exchanger 2 (specifically, upstream of the confluence C4 of the refrigerant passage 11 and the refrigerant passage 20), the refrigerant temperature sensor 42 is provided at the confluence C2 of the refrigerant passage 14 and the refrigerant passage 16, the refrigerant temperature sensor 43 is provided at the confluence C3 of the refrigerant passage 15 and the refrigerant passage 18, and the refrigerant temperature sensor 44 is provided on the refrigerant passage 17 downstream of the second battery heat exchanger 6b and the IHX 6c. In addition, the refrigerant pressure sensor 51 is provided on the refrigerant passage 11 downstream of the cascade heat exchanger 2, the refrigerant pressure sensor 52 is provided on the refrigerant passage 15 downstream of the motor 4, and the refrigerant pressure sensor 53 is provided on the refrigerant passage 17 downstream of the second battery heat exchanger 6b and the IHX 6c.

The control device 80 supplies control signals to the compressor 1, the flow control valves V1, V2, V3, and the expansion valves E1, E2, E3 on the basis of detection signals from the above-mentioned sensors 41 to 44, 51 to 53, 71 to 73, thereby controlling these. In particular, in the present embodiment, the control device 80 controls the opening degrees of the expansion valve E2 and the expansion valve E3 (hereinbelow, referred to as the “E2 opening degree” and the “E3 opening degree” as appropriate) on the basis of the battery temperature detected by the battery temperature sensor 72, so as to ensure the cooling capability for the battery 6 using the refrigerant while restraining a reduction in the efficiency of the cooling system 100 (in particular, the first heat cycle circuit 100a) (details will be described further below).

### Control Method

Hereinbelow, control performed by the control device 80 in the present embodiment will be described. First, a basic concept of the control according to the present embodiment will be described.

The balance between the efficiency (e.g., coefficient of performance: COP) and the cooling capability of the cooling system 100 changes in accordance with various conditions such as the traveling state of the vehicle 200, the presence or absence of the use of cooling when the vehicle 200 is traveling, and the charging speed of the battery 6 (slow charging, quick charging). Thus, in order to improve the range of the vehicle 200 and reduce the charging time of the battery 6, it is desirable to adjust the balance between the cooling capability and the efficiency, taking these conditions into consideration.

In the cooling system 100 according to the present embodiment, the temperature of the refrigerant discharged from compressor 1 (hereinbelow, referred to as the “compressor discharge temperature” as appropriate), the cooling capability of the entire system, and the efficiency of the entire system change in accordance with the balance between the ratio of the refrigerant that is supplied from the confluence C2 to the compressor 1 (the first compressor 1a) through the refrigerant passage 17, the expansion valve E2, and the second battery heat exchanger 6b (hereinbelow, referred to as the “first refrigerant ratio” as appropriate) and the ratio of the refrigerant that is supplied from the confluence C2 to the compressor 1 (the second compressor 1b) through the refrigerant passage 18, the expansion valve E3, the confluence C3, and the refrigerant passage 19 (hereinbelow, referred to as the “second refrigerant ratio” as appropriate). In this case, the first and second refrigerant ratios are adjusted by the expansion valve E2 on the refrigerant passage 17 and the expansion valve E3 on the refrigerant passage 18, respectively. Basically, the compressor discharge temperature tends to increase as the first refrigerant ratio increases and decrease as the second refrigerant ratio increases, the cooling capability of the entire system tends to increase as the first refrigerant ratio increases, and the efficiency of the entire system tends to decrease as the first refrigerant ratio increases and decrease as the second refrigerant ratio increases.

In one example, during traveling of the vehicle 200, the control device 80 controls the expansion valves E2, E3 so as to make the first and second refrigerant ratios relatively small to reduce the cooling capability and ensure the efficiency in order to extend the range. In another example, during external charging of the battery 6, the control device 80 controls the expansion valves E2, E3 so as to set each of the first and second refrigerant ratios to a medium value, to increase the cooling capability to complete the charging within a short time, to make the compressor discharge temperature equal to or lower than a predetermined temperature (e.g., 180° C.), and to make the efficiency equal to or higher than a predetermined value (e.g., 1 or more).

Next, specific control performed by the control device 80 on the expansion valves E2, E3 in the present embodiment will be described.

(Control during Steady Traveling or Slow Charging) First, control that is performed during steady traveling or slow charging in the present embodiment will be described with reference to (a) of FIG. 5 and (b) of FIG. 5. (a) of FIG. 5 shows control of the E2 opening degree (vertical axis) that is performed in accordance with the battery temperature (horizontal axis), and (b) of FIG. 5 shows control of the E3 opening degree (vertical axis) that is performed in accordance with the E2 opening degree (horizontal axis). (a) and (b) of FIG. 5 correspond to control maps for the E2 opening degree and the E3 opening degree that are used during steady traveling or slow charging.

In the present embodiment, the control device 80 performs the control as shown in (a) and (b) of FIG. 5 during steady traveling of the vehicle 200 or during slow charging of the battery 6 (refers to external charging, the same applies hereinafter.) For example, the steady traveling means a case in which the acceleration/deceleration (absolute value) of the vehicle 200 is less than a predetermined value, and the slow charging means a case in which the battery 6 is charged at a C-rate less than a predetermined rate (in one example, 1C). During such steady traveling or slow charging, the battery 6 gently generates heat (approximately 0.4 KW). Note that the C-rate means the charging speed of the battery 6 and is basically defined as the ratio of a charging current value to the battery capacity.

Specifically, during steady traveling or slow charging, as shown in (a) of FIG. 5, when the battery temperature is within a first region R1 on the low temperature side, the control device 80 maintains the E2 opening degree at 0 (fully closed, i.e., the first opening degree). Accordingly, it is possible to ensure the efficiency of the entire system by reducing the first refrigerant ratio when the battery temperature is relatively low. Note that the first region R1 corresponds to a battery temperature range in which the battery 6 (cells 62) can be sufficiently cooled by the first battery heat exchanger 6a that indirectly cools the cells 62, without using the second battery heat exchanger 6b that directly cools the cells 62. In addition, when the control device 80 sets the E2 opening degree to 0 (fully closed) in this manner, the control device 80 also sets the E3 opening degree to 0 (fully closed) ((b) of FIG. 5). Accordingly, it is possible to effectively ensure the efficiency of the entire system by also reducing the second refrigerant ratio.

On the other hand, as shown in (a) of FIG. 5, when the battery temperature is within a second region R2 that is on the higher temperature side than the first region R1, the control device 80 linearly increases the E2 opening degree as the battery temperature rises. Accordingly, it is possible to ensure the cooling capability for the battery 6 using the refrigerant by increasing the first refrigerant ratio. More specifically, when the control device 80 increases the E2 opening degree in accordance with the battery temperature in this manner, the control device 80 limits the E2 opening degree to a predetermined limit opening degree Lim1 or less, that is, increases the E2 opening degree within the range of the limit opening degree Lim1 or less to make the compressor discharge temperature equal to or lower than a predetermined temperature (e.g., 180° C.). Note that the predetermined temperature of the compressor discharge temperature is set on the basis of a temperature at which oil in the refrigerant stops functioning when the temperature of the refrigerant exceeds the predetermined temperature, thereby causing seizure of a sliding surface, a reduction in the sealability, or deterioration of the oil. The limit opening degree Lim1 is set in advance on the basis of such a predetermined temperature.

Furthermore, when the control device 80 controls the E2 opening degree as described above during the steady traveling or slow charging, as shown in (b) of FIG. 5, the control device 80 also linearly increases the E3 opening degree as the E2 opening degree increases. Accordingly, it is possible to restrain a rise in the compressor discharge temperature by also increasing the second refrigerant ratio in accordance with the increase in the first refrigerant ratio.

Note that the reason why the rise in the compressor discharge temperature can be restrained by increasing the second refrigerant ratio (that is, increasing the refrigerant supplied to the compressor 1 through the refrigerant passages 18, 19) as described above is as follows. In the present embodiment, the compressor 1 is configured to increase the pressure of the refrigerant in two stages using the first and second compressors 1a, 1b. In addition, the first compressor 1a on the upstream side is supplied with the refrigerant decompressed by the expansion valve E2, and, on the other hand, the second compressor 1b on the downstream side is supplied with the refrigerant that is a mixture of the refrigerant discharged from the first compressor 1a with the refrigerant in a relatively low enthalpy state decompressed by the expansion valve E3 (that is, the refrigerant having a lower enthalpy than the refrigerant that has been increased in pressure by the first compressor 1a described above). This prevents the refrigerant that has been increased in pressure by the second compressor 1b from becoming a high temperature, and can restrain a rise in the compressor discharge temperature.

### (Control During Quick Charging)

Next, control that is performed during quick charging in the present embodiment will be described with reference to (a) and (b) of FIG. 6. (a) of FIG. 6 shows control of the E2 opening degree (vertical axis) that is performed in accordance with the battery temperature (horizontal axis), and FIG. 6(b) shows control of the E3 opening degree (vertical axis) that is performed in accordance with the E2 opening degree (horizontal axis). (a) and (b) of FIG. 6 correspond to control maps for the E2 opening degree and the E3 opening degree that are used during quick charging.

In the present embodiment, the control device 80 performs the control as shown in (a) and (b) of FIG. 6 during quick charging of the battery 6. For example, the quick charging means a case in which the battery 6 is charged at a C-rate equal to or more than a predetermined rate (in one example, 2C, 3C, or 4C). During such quick charging, in the battery 6, the amount of heat generated inside the cell 62 becomes larger than the amount of heat dissipated from an end face of the cell 62. Thus, during quick charging, there is a higher requirement for directly cooling the cells 62 than during slow charging in order to restrain a local temperature rise in the battery 6.

Specifically, in (a) of FIG. 6, reference character G1 indicates a graph (same as (a) of FIG. 5) that is used during steady traveling or slow charging described above, and reference characters G2, G3 indicate graphs that are used during quick charging. More specifically, the graph G3 is a graph that is used when charging is performed at a higher C-rate than the graph G2. For example, the graph G2 is used when the C-rate during charging is 3C, and the graph G3 is used when the C-rate during charging is 4C.

As shown in the graphs G2, G3, during quick charging, the control device 80 maintains the E2 opening degree at 0 (fully closed) when the battery temperature is within the first region R1 on the low temperature side, linearly increases the E2 opening degree as the battery temperature rises when the battery temperature is within the second region R2 that is on the higher temperature side than the first region R1, and maintains the E2 opening degree at the limit opening degree Lim1 when the battery temperature is within a third region R3 that is on the higher temperature side than the second region R2. In particular, as the C-rate during charging increases, the control device 80 reduces the first region R1 (R13<R12<R11), expands the third region R3 (R33>R32), and further increases the rate of change (increase rate) of the E2 opening degree with respect to the battery temperature in the second region R2.

Accordingly, when the C-rate during charging of the battery 6 is high, it is possible to improve the cooling capability for the battery 6 using the refrigerant by increasing the first refrigerant ratio. Specifically, it is possible to effectively cool the battery cells 62 of the battery 6.

Furthermore, when the control device 80 controls the E2 opening degree as described above during quick charging, as shown in (b) of FIG. 6 FIG. 6(b), the control device 80 also linearly increases the E3 opening degree as the E2 opening degree increases. Accordingly, it is possible to restrain a rise in the compressor discharge temperature by also increasing the second refrigerant ratio in accordance with the increase in the first refrigerant ratio. Note that the reason why the rise in the compressor discharge temperature can be restrained in this manner is as described above.

### (Control During Abnormal Heat Generation of Battery)

Next, control that is performed during abnormal heat generation of the battery 6 in the present embodiment will be described with reference to (a) and (b) of FIG. 7. (a) of FIG. 7 FIG. 7(a) shows control of the E2 opening degree (vertical axis) that is performed in accordance with the battery temperature (horizontal axis), and (b) of FIG. 7 FIG. 7(b) shows control of the E3 opening degree (vertical axis) that is performed in accordance with the E2 opening degree (horizontal axis).

In the present embodiment, the control device 80 performs the control as shown in (a) and (b) of FIG. 7 during abnormal heat generation of the battery 6. The abnormal heat generation of the battery 6 means a case in which heat generation occurs due to thermal runaway caused by an internal short circuit or the like in the battery 6 (this thermal runaway is caused by various reactions and thermal decomposition inside the battery 6). In this case, the control device 80 determines the occurrence of such abnormal heat generation by detecting an internal short circuit in the battery 6 from a current value or a voltage value of the battery 6, or by detecting gas generated inside the battery 6. Alternatively, the control device 80 may determine the occurrence of abnormal heat generation from changes in the battery temperature over time.

Specifically, as shown in (a) of FIG. 7, when the battery 6 is not abnormally generating heat, as described above (refer to (a) of FIG. 7), the control device 80 maintains the E2 opening degree at 0 (fully closed) when the battery temperature is within the first region R1 on the low temperature side, and linearly increases the E2 opening degree as the battery temperature rises when the battery temperature is within the second region R2 that is on the higher temperature side than the first region R1. However, when the control device 80 detects, for example, an internal short circuit of the battery 6 during abnormal heat generation of the battery 6 (arrow A1), the control device 80 first increases the E2 opening degree to the limit opening degree (first opening degree) Lim1 promptly (in steps) as indicated by arrow A2. Accordingly, it is possible to promptly increase the cooling capability for the battery 6 using the refrigerant and restrain abnormal heat generation of the battery 6.

Then, when the rise in the battery temperature continues even after the E2 opening degree is set to the limit opening degree Lim1 as described above, the control device 80 increases the E2 opening degree promptly (in steps) to a limit opening degree (second opening degree) Lim2 that is larger than the limit opening degree Lim1, as indicated by arrow A3. The limit opening degree Lim2 is a large E2 opening degree that may cause the compressor discharge temperature to exceed the predetermined temperature described above (that is, may cause a decline in the oil function or oil deterioration). Thus, by setting the E2 opening degree to such a limit opening degree Lim2, it is possible to give top priority to cooling of the battery 6 by allowing the compressor discharge temperature to exceed the predetermined temperature and maximizing the cooling capability for the battery 6 using the refrigerant. Accordingly, it is possible to restrain abnormal heat generation of the battery 6 and avoid a battery fire, which is the worst case.

On the other hand, when the control device 80 controls the E2 opening degree as described above during abnormal heat generation of the battery 6, the control device 80 controls the E3 opening degree in accordance with the E2 opening degree as shown in (b) of FIG. 7. First, when the E2 opening degree is less than the limit opening degree Lim1 described above (at this time, basically, abnormal heat generation of the battery 6 is not occurring), the control device 80 also linearly increases the E3 opening degree as the E2 opening degree increases, in the same manner as in (b) of FIG. 5 and (b) of FIG. 6. Then, when the E2 opening degree is equal to or larger than the limit opening degree Lim1, that is, when the E2 opening degree is made equal to or larger than the limit opening degree Lim1 in order to deal with the occurrence of abnormal heat generation of the battery 6 ((a) of FIG. 7), the control device 80 linearly reduces the E3 opening degree as the E2 opening degree increases. Accordingly, it is possible to allow the compressor discharge temperature to rise and give top priority to cooling of the battery 6.

### Action and Effects

Next, the action and effects of the cooling system 100 according to the present embodiment will be described. In the present embodiment, the cooling system performs cooling inside the vehicle 200 by circulating the refrigerant containing CO₂ (CO₂ refrigerant) and includes the compressor 1 that compresses the refrigerant, the cascade heat exchanger 2 for cooling the refrigerant compressed by the compressor 1, the air conditioning heat exchanger 5a and the first battery heat exchanger 6a that use the refrigerant cooled by the cascade heat exchanger 2, the refrigerant passage 17 for supplying the refrigerant to the battery 6 inside the vehicle 200 to cool the battery 6 using the refrigerant cooled by the cascade heat exchanger 2 and supplying the refrigerant that has been used for cooling in the battery 6 to the compressor 1, the expansion valve E2 for expanding the refrigerant, the expansion valve E2 being provided on the refrigerant passage 17 upstream of the battery 6, and the control device 80 configured to obtain the battery temperature and control the expansion valve E2 on the basis of the battery temperature, and the control device 80 is configured to increase the opening degree of the expansion valve E2 within the range of the limit opening degree Lim1 or less as the battery temperature rises when abnormal heat generation of the battery 6 is not occurring, and set the opening degree of the expansion valve E2 to the limit opening degree Lim2 larger than the limit opening degree Lim1 when abnormal heat generation of the battery 6 is occurring.

According to the present embodiment as described above, it is possible to appropriately achieve both air conditioning of the vehicle 200 and cooling of the battery 6 using the refrigerant circulated in the cooling system 100. In addition, according to the present embodiment, when abnormal heat generation of the battery 6 is not occurring, it is possible to ensure the cooling capability for the battery 6 using the refrigerant while restraining a reduction in the efficiency of the entire system by increasing the opening degree of the expansion valve E2 within the range of the limit opening degree Lim1 or less as the battery temperature rises. On the other hand, according to the present embodiment, when abnormal heat generation of the battery 6 is occurring, it is possible to maximize the cooling capability for the battery 6 using the refrigerant and give top priority to cooling of the battery 6 by setting the opening degree of the expansion valve E2 to the limit opening degree Lim2 larger than the limit opening degree Lim1. As a result, it is possible to restrain abnormal heat generation of the battery 6, and avoid a battery fire, which is the worst case.

In addition, according to the present embodiment, the control device 80 is configured to first set the opening degree of the expansion valve E2 to the limit opening degree Lim1 when abnormal heat generation of the battery 6 occurs, and then set the opening degree of the expansion valve E2 to the limit opening degree Lim2 when the temperature of the battery continues to rise. Accordingly, since the opening degree of the expansion valve E2 is controlled in stages from the limit opening degree Lim1 to the limit opening degree Lim2, it is possible to increase the cooling capability for the battery 6 using the refrigerant while minimizing the rise in the compressor discharge temperature.

In addition, according to the present embodiment, the cooling system 100 further includes the refrigerant passages 18, 19 for supplying the refrigerant that has been used for cooling in the air conditioning heat exchanger 5a and the first battery heat exchanger 6a to the compressor 1, without passing the refrigerant through the refrigerant passage 17, and the expansion valve E3 for expanding the refrigerant, the expansion valve E3 being provided on the refrigerant passage 18, and the control device 80 is configured to increase the opening degree of the expansion valve E3 as the opening degree of the expansion valve E2 increases when abnormal heat generation of the battery 6 is not occurring, and reduce the opening degree of the expansion valve E3 as the opening degree of the expansion valve E2 increases when abnormal heat generation of the battery 6 is occurring. Accordingly, when abnormal heat generation of the battery 6 is not occurring, it is possible to restrain the rise in the compressor discharge temperature by increasing the flow rate of the refrigerant supplied from the refrigerant passages 18, 19 to the compressor 1 through the expansion valve E3 in accordance with the increase in the flow rate of the refrigerant supplied from the refrigerant passage 17 to the compressor 1 through the expansion valve E2. As a result, it is possible to restrain the occurrence of a decline in the function of oil in the refrigerant or deterioration of the oil. On the other hand, when abnormal heat generation of the battery 6 is occurring, it is possible to allow the compressor discharge temperature to rise and give top priority to cooling of the battery 6 by reducing the flow rate of the refrigerant supplied from the refrigerant passages 18, 19 to the compressor 1 through the expansion valve E3.

In addition, according to the present embodiment, the limit opening degree Lim1 is set on the basis of the opening degree of the expansion valve E2 for making the compressor discharge temperature equal to or lower than the predetermined temperature. Accordingly, when abnormal heat generation of the battery 6 is not occurring, the compressor discharge temperature can be made equal to or lower than the predetermined temperature by limiting the opening degree of the expansion valve E2 to the limit opening degree Lim1 or less. As a result, it is possible to effectively restrain a decline in the function of oil in the refrigerant or deterioration of the oil.

In addition, according to the present embodiment, the control device 80 is configured to determine whether abnormal heat generation of the battery 6 is occurring by detecting an internal short circuit of the battery 6. Accordingly, it is possible to properly determine the occurrence of abnormal heat generation of the battery 6.

In addition, according to the present embodiment, the cooling system 100 further includes the second battery heat exchanger 6b for directly cooling the plurality of cells 62 inside the battery 6 using the refrigerant by passing the refrigerant in the refrigerant passage 17 around the plurality of cells 62, and the second battery heat exchanger 6b is supplied with the refrigerant decompressed by the expansion valve E2. According to the present embodiment as described above, since the plurality of cells 62 are directly cooled using the refrigerant in the second battery heat exchanger 6b, it is possible to effectively cool the plurality of cells 62 of the battery 6. In this case, since it is not desirable to supply the high-pressure refrigerant from the compressor 1 as it is to the second battery heat exchanger 6b because the pressure resistance of the battery pack 61 and the like is relatively low, the refrigerant from the compressor 1 is decompressed by the expansion valve E2 and supplied to the second battery heat exchanger 6b in the present embodiment. Accordingly, it is possible to properly protect the inside of the battery 6 (such as the plurality of cells 62).

In addition, according to the present embodiment, as the heat exchanger that uses the refrigerant cooled by the cascade heat exchanger 2, the air conditioning heat exchanger 5a for performing air conditioning of the vehicle 200, and the first battery heat exchanger 6a that indirectly cools the plurality of cells 62 using the refrigerant by supplying the refrigerant to the outside of the battery pack 61 including the plurality of cells 62 in the battery 6 are used. Accordingly, by using the first battery heat exchanger 6a that indirectly cools the plurality of cells 62 by supplying the refrigerant to the outside of the battery pack 61, it is possible to appropriately cool the battery 6 and achieve relatively large heat exchange with the refrigerant.

In addition, according to the present embodiment, the cascade heat exchanger 2 is configured to perform heat exchange between the first heat cycle circuit 100a including at least the compressor 1, the air conditioning heat exchanger 5a, and the first battery heat exchanger 6a and the second heat cycle circuit 100b including the outside air heat exchanger 30 that exchanges heat with the outside air separately from the first heat cycle circuit 100a. Accordingly, by causing the first heat cycle circuit 100a to perform heat exchange (cascade heat exchange) with the second heat cycle circuit 100b that exchanges heat with the outside air, it is possible to improve the efficiency of the entire system of the first heat cycle circuit 100a, in other words, reduce the work of the compressor 1.

In addition, according to the present embodiment, the cooling system 100 further cools, using the refrigerant cooled by the cascade heat exchanger 2, the motor 4 that drives the vehicle 200 using electric power of the battery 6. Accordingly, it is possible to appropriately achieve cooling of various components inside the vehicle 200, such as the motor 4, using the refrigerant circulated in the cooling system 100.

### [Modifications]

Although, in the embodiment described above, the cooling system 100 includes the first heat cycle circuit 100a and the second heat cycle circuit 100b, in another example, the cooling system 100 may include only the first heat cycle circuit 100a. In that case, the cascade heat exchanger 2 may be configured as the outside air heat exchanger. Note that, when the cooling system 100 includes the first heat cycle circuit 100a and the second heat cycle circuit 100b, although the system efficiency becomes high (that is, the work of the compressor 1 can be reduced), the configuration becomes complicated. Thus, when simplification of the configuration is prioritized over the system efficiency, the cooling system 100 preferably includes only the first heat cycle circuit 100a.

In addition, although, in the embodiment described above, the temperature of the battery 6 is detected by the battery temperature sensor 72, in another example, the temperature of the battery 6 may be estimated in accordance with the current value or the voltage value of the battery 6, the output requirements of the battery 6, the charging speed requirements of the battery 6, or the like. In still another example, the temperature of the battery 6 may be estimated on the basis of the temperature of the refrigerant detected by the refrigerant temperature sensor 44 that is provided on the refrigerant passage 17 downstream of the second battery heat exchanger 6b.

### REFERENCE SIGNS LIST

1 compressor
1a first compressor
1b second compressor
2 heat exchanger (cascade heat exchanger)
4 motor
5 air conditioner
5a air conditioning heat exchanger
6 battery
6a first battery heat exchanger
6b second battery heat exchanger
11 to 20 refrigerant passage
41, 42, 43, 44 refrigerant temperature sensor
51, 52, 53 refrigerant pressure sensor
61 battery pack
62 cell
80 control device
100 cooling system
100a first heat cycle circuit
100b second heat cycle circuit
200 vehicle
E1, E2, E3 expansion valve
V1, V2, V3 flow control valve

1. A cooling system that performs cooling inside a vehicle by circulating a refrigerant, the cooling system comprising:
a compressor that compresses the refrigerant, the refrigerant containing CO₂;
a first heat exchanger for cooling the refrigerant compressed by the compressor;
a second heat exchanger for performing at least air conditioning of the vehicle using the refrigerant cooled by the first heat exchanger;
a refrigerant passage for supplying the refrigerant to a battery inside the vehicle to cool the battery using the refrigerant cooled by the first heat exchanger and supplying the refrigerant that has been used for cooling in the battery to the compressor;
an expansion valve for expanding the refrigerant, the expansion valve being provided on the refrigerant passage upstream of the battery; and
a processing circuitry configured to obtain a temperature of the battery; and control the expansion valve based on the temperature of the battery, the controlling the expansion valve including: increasing an opening degree of the expansion valve below a predetermined first opening degree or less as the temperature of the battery rises when abnormal heat generation of the battery does not occur, the abnormal heat generation of the battery being a temperature increase above a predetermined rate, and
increasing the opening degree of the expansion valve to a second opening degree larger than the first opening degree when the abnormal heat generation of the battery is occurring.

2. The cooling system according to claim 1, wherein the processing circuitry is configured to first set the opening degree of the expansion valve to the first opening degree when abnormal heat generation of the battery occurs, and then set the opening degree of the expansion valve to the second opening degree when the temperature of the battery continues to rise.

3. The cooling system according to claim 1, wherein the refrigerant passage is defined as a first refrigerant passage and the expansion valve is defined as a first expansion valve,
the cooling system further includes:
a second refrigerant passage for supplying the refrigerant that has been used for cooling in the second heat exchanger to the compressor, without passing the refrigerant through the first refrigerant passage; and
a second expansion valve for expanding the refrigerant, the second expansion valve being provided on the second refrigerant passage, and
the processing circuitry is configured to increase an opening degree of the second expansion valve as the opening degree of the first expansion valve increases when abnormal heat generation of the battery is not occurring, and reduce the opening degree of the second expansion valve as the opening degree of the first expansion valve increases when abnormal heat generation of the battery is occurring.

4. The cooling system according to claim 2, wherein the refrigerant passage is defined as a first refrigerant passage and the expansion valve is defined as a first expansion valve,
the cooling system further includes:
a second refrigerant passage for supplying the refrigerant that has been used for cooling in the second heat exchanger to the compressor, without passing the refrigerant through the first refrigerant passage; and
a second expansion valve for expanding the refrigerant, the second expansion valve being provided on the second refrigerant passage, and
the processing circuitry is configured to increase an opening degree of the second expansion valve as the opening degree of the first expansion valve increases when abnormal heat generation of the battery is not occurring, and reduce the opening degree of the second expansion valve as the opening degree of the first expansion valve increases when abnormal heat generation of the battery is occurring.

5. The cooling system according to claim 1, wherein the first opening degree is set based on making the temperature of the refrigerant discharged from the compressor equal to or lower than a predetermined temperature.

6. The cooling system according to claim 2, wherein the first opening degree is set based on making the temperature of the refrigerant discharged from the compressor equal to or lower than a predetermined temperature.

7. The cooling system according to claim 1, wherein the processing circuitry is configured to determine whether abnormal heat generation of the battery is occurring by detecting an internal short circuit of the battery.

8. The cooling system according to claim 2, wherein the processing circuitry is configured to determine whether abnormal heat generation of the battery is occurring by detecting an internal short circuit of the battery.

9. The cooling system according to claim 1, further comprising a battery heat exchanger for directly cooling a plurality of cells inside the battery using the refrigerant by passing the refrigerant in the refrigerant passage around the plurality of cells, wherein
the battery heat exchanger is supplied with the refrigerant decompressed by the expansion valve.

10. The cooling system according to claim 2, further comprising a battery heat exchanger for directly cooling a plurality of cells inside the battery using the refrigerant by passing the refrigerant in the refrigerant passage around the plurality of cells, wherein
the battery heat exchanger is supplied with the refrigerant decompressed by the expansion valve.

11. The cooling system according to claim 1, wherein the second heat exchanger includes:
an air conditioning heat exchanger for performing air conditioning of the vehicle; and
a battery heat exchanger for indirectly cooling a plurality of cells using the refrigerant by supplying the refrigerant to outside of a battery pack including the plurality of cells in the battery.

12. The cooling system according to claim 2, wherein the second heat exchanger includes:
an air conditioning heat exchanger for performing air conditioning of the vehicle; and
a battery heat exchanger for indirectly cooling a plurality of cells using the refrigerant by supplying the refrigerant to outside of a battery pack including the plurality of cells in the battery.

13. The cooling system according to claim 1, wherein the first heat exchanger is a cascade heat exchanger that performs heat exchange between a first heat cycle circuit and a second heat cycle circuit,
the first heat cycle circuit includes at least the compressor, the second heat exchanger, the refrigerant passage, and the expansion valve, and
the second heat cycle circuit includes an outside air heat exchanger that exchanges heat with outside air separately from the first heat cycle circuit.

14. The cooling system according to claim 2, wherein the first heat exchanger is a cascade heat exchanger that performs heat exchange between a first heat cycle circuit and a second heat cycle circuit,
the first heat cycle circuit includes at least the compressor, the second heat exchanger, the refrigerant passage, and the expansion valve, and
the second heat cycle circuit includes an outside air heat exchanger that exchanges heat with outside air separately from the first heat cycle circuit.

15. The cooling system according to claim 1, wherein the cooling system is configured to further cool, using the refrigerant cooled by the first heat exchanger, a motor that drives the vehicle using electric power of the battery.

16. The cooling system according to claim 2, wherein the cooling system is configured to further cool, using the refrigerant cooled by the first heat exchanger, a motor that drives the vehicle using electric power of the battery.

17. A vehicle including:
a battery;
a motor that drives the vehicle using electric power of the battery; and
a cooling system that performs cooling inside the vehicle by circulating a refrigerant containing CO₂, the cooling system comprising:
a compressor that compresses the refrigerant, the refrigerant containing CO₂;
a first heat exchanger for cooling the refrigerant compressed by the compressor;
a second heat exchanger for performing at least air conditioning of the vehicle using the refrigerant cooled by the first heat exchanger;
a refrigerant passage for supplying the refrigerant to a battery inside the vehicle to cool the battery using the refrigerant cooled by the first heat exchanger and supplying the refrigerant that has been used for cooling in the battery to the compressor;
an expansion valve for expanding the refrigerant, the expansion valve being provided on the refrigerant passage upstream of the battery; and
a processing circuitry configured to obtain a temperature of the battery; and control the expansion valve based on the temperature of the battery, the controlling the expansion valve including: increasing an opening degree of the expansion valve below a predetermined first opening degree or less as the temperature of the battery rises when abnormal heat generation of the battery does not occur, the abnormal heat generation of the battery being a temperature increase above a predetermined rate, and
increasing the opening degree of the expansion valve to a second opening degree larger than the first opening degree when the abnormal heat generation of the battery is occurring.

18. The vehicle according to claim 17, wherein the processing circuitry is configured to first set the opening degree of the expansion valve to the first opening degree when abnormal heat generation of the battery occurs, and then set the opening degree of the expansion valve to the second opening degree when the temperature of the battery continues to rise.

19. The vehicle according to claim 17, wherein the refrigerant passage is defined as a first refrigerant passage and the expansion valve is defined as a first expansion valve, and
the cooling system further includes:
a second refrigerant passage for supplying the refrigerant that has been used for cooling in the second heat exchanger to the compressor, without passing the refrigerant through the first refrigerant passage; and
a second expansion valve for expanding the refrigerant, the second expansion valve being provided on the second refrigerant passage, wherein
the processing circuitry is configured to increase an opening degree of the second expansion valve as the opening degree of the first expansion valve increases when abnormal heat generation of the battery is not occurring, and reduce the opening degree of the second expansion valve as the opening degree of the first expansion valve increases when abnormal heat generation of the battery is occurring.

20. A method for performing cooling of a vehicle, comprising:
compressing, by a compressor, a refrigerant containing CO₂;
cooling, by a first heat exchanger, the refrigerant compressed by the compressor;
performing, by a second heat exchanger, at least air conditioning of the vehicle using the refrigerant cooled by the first heat exchanger;
supplying, by a refrigerant passage, the refrigerant to a battery inside the vehicle to cool the battery using the refrigerant cooled by the first heat exchanger and supplying the refrigerant that has been used for cooling in the battery to the compressor;
expanding, by an expansion valve, the refrigerant, the expansion valve being provided on the refrigerant passage upstream of the battery; and
by processing circuitry, obtaining a temperature of the battery and controlling the expansion valve based on the temperature of the battery, the controlling the expansion valve including:
increasing an opening degree of the expansion valve below a predetermined first opening degree or less as the temperature of the battery rises when abnormal heat generation of the battery does not occur, the abnormal heat generation of the battery being a temperature increase above a predetermined rate, and
increasing the opening degree of the expansion valve to a second opening degree larger than the first opening degree when the abnormal heat generation of the battery is occurring.
